(19) United States
(12) Patent Application Publication
(10) Pub. No.: US 2007/0231610 A1
(43) Pub. Date: Oct. 4, 2007

(54) Magnetic recording medium

(75) Inventors: Koukichi Waki, Kanagawa (JP); Junichi Yamanouchi, Tokyo (JP); Takahiro Ishizuka, Kanagawa (JP); Yasushi Hattori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/730,164

(22) Filed: Mar. 29, 2007

(30) Foreign Application Priority Data
Mar. 30, 2006 (JP) 2006-95442

(51) Int. Cl. G11B 5/65; G11B 5/716

(52) U.S. Cl. 428/836.3; 428/843.6; 428/841.2

(57) ABSTRACT

A magnetic recording medium including a support having thereon a magnetic layer and a non-magnetic layer in this order, the magnetic layer being formed by applying and drying a magnetic nanoparticle dispersion liquid in which magnetic nanoparticles having a number average particle diameter of 20 nm or less are dispersed, applying the non-magnetic layer onto the magnetic layer, fixing the magnetic nanoparticles, and carrying out annealing for ferromagnetization, and the non-magnetic layer containing a gelatinous composition formed by gelating at least one selected from hydrolysates of the silane compound represented by (R¹⁰)ₘ—Si(X)₄₋ₘ and partial condensates thereof, wherein R¹⁰ represents a substituted or unsubstituted alkyl group, or a substituted or unsubstituted aryl group; X represents a hydroxy group or hydrolyzable group; and m represents an integer from 1 to 3.

### CROSS-REFERENCE TO RELATED APPLICATION

This application claims priority under 35 USC 119 from Japanese Patent Application No. 2006-95442, the disclosure of which is incorporated herein by reference.

### BACKGROUND OF THE INVENTION

1. Field of the Invention

The invention relates to a magnetic recording medium, and particularly to a magnetic recording medium containing magnetic nanoparticles in the magnetic layer.

2. Description of the Related Art

The enhancement of magnetic recording density requires the reduction of particle diameter. In magnetic recording media which are widely used as video tapes, computer tapes, disks, and the like, when ferromagnetic bodies thereof have the same mass, noise becomes smaller as particle diameter decreases.

CuAu type or Cu₃Au type ordered alloys have large crystal magnetic anisotropy due to the distortion that occurs at the time of ordering, and show ferromagnetism even when the magnetic particle diameter is reduced, or in the form of metallic nanoparticles. Accordingly, the above alloys can be regarded as promising materials for the enhancement of magnetic recording density.

On the other hand, when the recording density of a magnetic recording medium is enhanced, the floating quantity of a read/write head relative to the medium must be reduced. For a high-density recording medium having a density of 100 Gbpsi (gigabit/square inch) or more, the floating quantity of a head is estimated at 10 nm or less. In such cases, the smoothness will be at a problematic level even when polished glass is used. Furthermore, when an organic support or an aluminum substrate is used as a low-cost support, the smoothness is a particularly important matter.

Examples of the manufacturing method of magnetic nanoparticles comprising a CuAu type or Cu₃Au type alloy include (1) an alcohol reduction method using a primary alcohol, (2) a polyol reduction method using a secondary, tertiary, divalent, or trivalent alcohol, (3) a heat decomposition method, (4) an ultrasonic decomposition method, and (5) a strong reducing agent reduction method. Also, when classified according to reaction systems, examples of the method include (6) a polymer existence method, (7) a high-boiling point solvent method, (8) a normal micelle method, and (9) a reverse micelle method.

The nanoparticles manufactured by the above-mentioned methods have a face centered cubic crystal structure. Face-centered cubic crystals normally exhibit soft magnetism or paramagnetism. The state of soft magnetism or paramagnetism is not suitable to a recording media. In order to obtain ferromagnetic nanoparticles having a coercive force of 95.5 kA/m (1200 Oe) or more, which is necessary for magnetic recording media, annealing must be carried out at a temperature higher than the transformation temperature.

Magnetic nanoparticles are transformed into ferromagnetic nanoparticles by heat treatment. In a magnetic recording medium comprising such magnetic nanoparticles in a magnetic layer, magnetic nanoparticles can be fused by annealing to increase in the particle diameter. Furthermore, the magnetic layer has low film strength, and may exhibit poor adhesiveness to a substrate (support).

It is a well known method for hard disks or the like that diamond-like carbon is deposited by sputtering or vapor deposition as a protective layer on a magnetic layer. However, the protective layer cannot correct irregularities caused by magnetic nanoparticles, insufficiently prevents fusion, and has insufficient smoothness.

Furthermore, a method for forming a protective layer by a sol-gel method is disclosed (for example, see Japanese Patent Application Laid-Open (JP-A) No. 8-124148). In the method, starting materials of a sol are mixed with a solvent, and the mixture is applied and then subjected to a sol-gel reaction, thus a stable coating liquid cannot be obtained, and a smooth layer is hard to be formed after the application. Furthermore, fusion cannot be prevented because the protective layer is applied after heating treatment.

### SUMMARY OF THE INVENTION

The invention is a magnetic recording medium comprising a support having thereon a magnetic layer and a non-magnetic layer in this order, the magnetic layer being formed by applying and drying a magnetic nanoparticle dispersion liquid in which magnetic nanoparticles having a number average particle diameter of 20 nm or less have been dispersed, applying a non-magnetic layer onto the magnetic layer, fixing the magnetic nanoparticles, and annealing for ferromagnetization, furthermore, the non-magnetic layer comprising a gelatinous (gel-like) composition formed by gelating at least one of hydrolysates of a silane compound represented by the following formula (1) and partial condensates thereof.

(R¹⁰)ₘ—Si(X)₄₋ₘ Formula (1)

(In the formula (1), R¹⁰ represents a substituted or unsubstituted alkyl group, or a substituted or unsubstituted aryl group. X represents a hydroxy group or hydrolyzable group. m represents an integer of 1 to 3.)

### DESCRIPTION OF THE PREFERRED EMBODIMENTS

The magnetic recording medium of the invention has a magnetic layer on a support, and a non-magnetic layer is applied onto the magnetic layer. It is also preferable to apply a non-magnetic layer as a ground layer between the magnetic layer and support.

(Non-Magnetic Layer)

The non-magnetic layer comprises a gelatinous composition formed by gelating at least one of hydrolysates of a silane compound represented by the following formula (1) and partial condensates thereof.

(R¹⁰)ₘ—Si(X)₄₋ₘ Formula (1)

In the formula (1), R¹⁰ represents a substituted or unsubstituted alkyl group, or a substituted or unsubstituted aryl group. X represents a hydroxy group or hydrolyzable group. m represents an integer of 1 to 3.

The non-magnetic layer comprising a gelatinous composition has high strength and high heat resistance and is closely packed. Therefore, when the layer is provided between the magnetic layer and a support, advantageous effects such as enhancement of smoothness, adhesiveness, and film strength are obtained. Furthermore, the application of the layer onto the magnetic layer prevents fusion between magnetic nanoparticles during annealing, and achieves advantageous effects such as enhancement of smoothness and abrasion resistance. The prevention of the fusion between magnetic nanoparticles is considered to be due to the fact that the presence of the non-magnetic layer between particles prevents the movement of the particles.

Hydrolysates of the silane compound represented by the formula (1) or partial condensates thereof are further described below.

In the formula (1), R¹⁰ represents a substituted or unsubstituted alkyl group, or a substituted or unsubstituted aryl group.

Furthermore, X represents a hydroxy group or hydrolyzable group such as an alkoxy group (preferably an alkoxy group having 1 to 5 carbon atoms, such as a methoxy group or ethoxy group), halogen atom (e.g., Cl, Br, or I), or R²COO (R² is preferably a hydrogen atom or alkyl group having 1 to 5 carbon atoms, such as CH₃COO or C₂H₅COO). Among them, an alkoxy group is preferable, and a methoxy group or ethoxy group is most preferable. When R¹⁰ or X is present in plurality, the plural R¹⁰ and/or X may be the same as or different from each other. m represents an integer of 0 to 3. m is preferably 1 or 2, and most preferably 1.

The substituent of R¹⁰ is not particularly limited, and examples thereof include a halogen atom (e.g., fluorine, chlorine, or bromine), hydroxy group, mercapto group, carboxyl group, epoxy group, alkyl group (e.g., methyl, ethyl, i-propyl, propyl, or t-butyl), aryl group (e.g., phenyl or naphthyl), aromatic heterocycle group (e.g., furyl, pyrazolyl, or pyridyl), alkoxy group (e.g., methoxy, ethoxy, i-propoxy, or hexyloxy), aryloxy (e.g. phenoxy), alkylthio group (e.g., methylthio or ethylthio), arylthio group (e.g., phenylthio), alkenyl group (e.g., vinyl or 1-propenyl), acyloxy group (e.g., acetoxy, acryloyloxy or methacryloyloxy), alkoxycarbonyl group (e.g., methoxycarbonyl or ethoxycarbonyl), aryloxycarbonyl group (e.g., phenoxycarbonyl), carbamoyl group (e.g., carbamoyl, N-methylcarbamoyl, N,N-dimethylcarbamoyl, or N-methyl-N-octylcarbamoyl), acylamino group (e.g., acetylamino, benzoylamino, acrylamino, or methacrylamino). The above substituents may be further substituted.

When R¹⁰ is present in plurality, at least one of them is preferably a substituted alkyl group or substituted aryl group, and an organosilane compound having a vinyl polymerizable substituent represented by the following formula (2) is preferable.

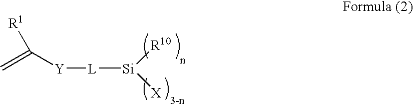

In the formula (2), R¹ represents a hydrogen atom, methyl group, methoxy group, alkoxycarbonyl group, cyano group, fluorine, or chlorine atom. Examples of the alkoxycarbonyl group include a methoxycarbonyl group and ethoxycarbonyl group. R¹ is preferably a hydrogen atom, methyl group, methoxy group, methoxycarbonyl group, cyano group, fluorine, or chlorine atom, more preferably a hydrogen atom, methyl group, methoxycarbonyl group, fluorine, or chlorine atom, and particularly preferably a hydrogen atom or methyl group.

Y represents a single bond, ester group, amide group, ether group, or urea group. Among them, a single bond, ester group, or amide group is preferable, a single bond or ester group is more preferable, and an ester group is particularly preferable.

L represents a divalent linking chain. Specific examples thereof include a substituted or unsubstituted alkylene group, substituted or unsubstituted arylene group, substituted or unsubstituted alkylene group having a linking group (e.g., ether, ester, or amide) therein, and substituted or unsubstituted arylene group having a linking group therein. Among them, a substituted or unsubstituted alkylene group, substituted or unsubstituted arylene group, and alkylene group having a linking group therein are preferable, an unsubstituted alkylene group, unsubstituted arylene group, and alkylene group having an ether or ester linking group are more preferable, and an unsubstituted alkylene group and alkylene group having an ether or ester linking group are particularly preferable. Examples of the substituent include a halogen atom, hydroxy group, mercapto group, carboxyl group, epoxy group, alkyl group, and aryl group. These substituents may be further substituted.

n represents 0 or 1. When X is present in plurality, the plural X may be the same as or different from each other. n is preferably 0. R¹⁰ is equivalent to that in the formula (1), and preferably a substituted or unsubstituted alkyl group or unsubstituted aryl group, and more preferably an unsubstituted alkyl group or unsubstituted aryl group. X is also equivalent to that in the formula (1), and preferably a halogen atom, hydroxy group, or unsubstituted alkoxy group, more preferably a chlorine atom, hydroxy group, or unsubstituted alkoxy group having 1 to 6 carbon atoms, more preferably a hydroxy group or alkoxy group having 1 to 3 carbon atoms, and particularly preferably a methoxy group.

The silane compound represented by formulae (1) and (2) (hereinafter may be simply referred to as “silane compound”) may be used in combination of two or more of them. Specific examples of the silane compound represented by the formulae (1) and (2) (compound examples (1) to (53)) are listed below, but the invention is not limited to them.

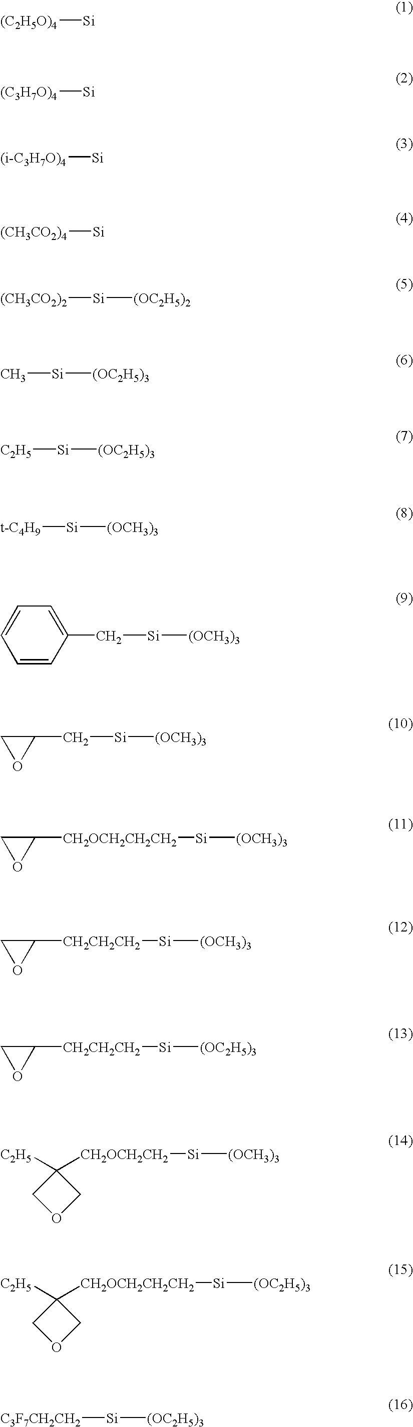

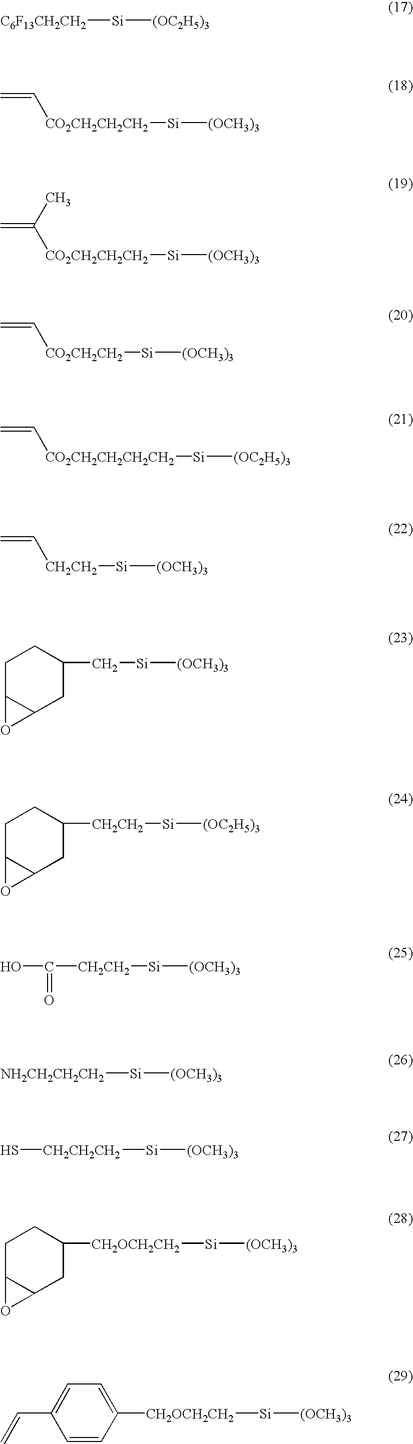

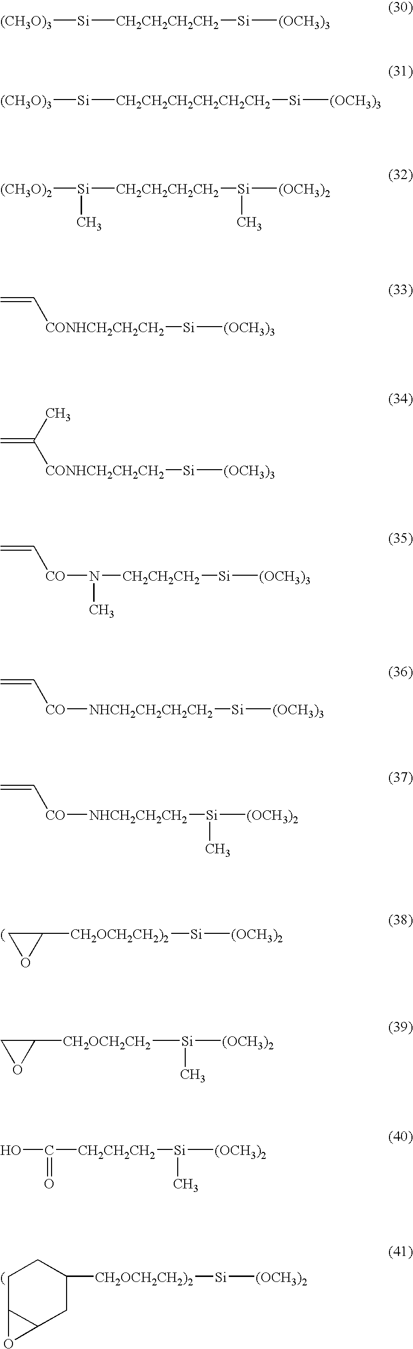

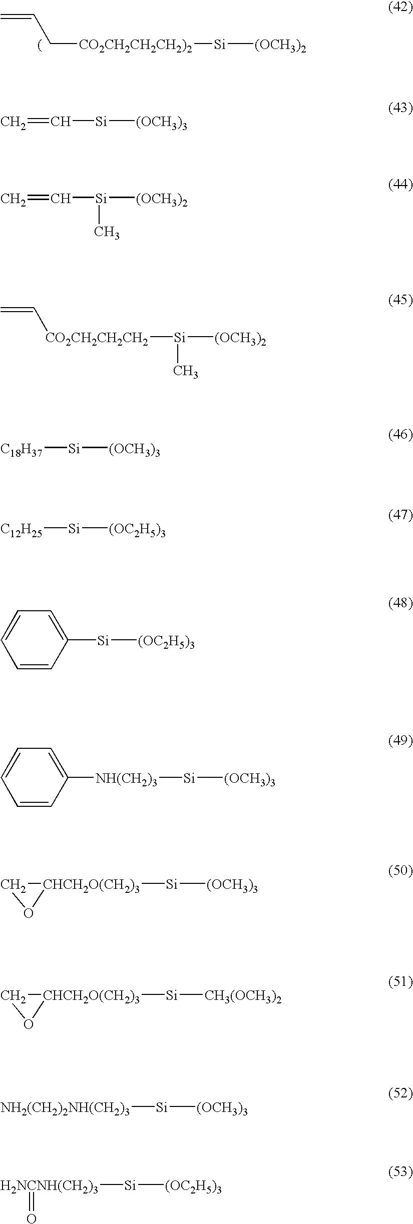

The hydrolysis or condensation reaction of the silane compound can be carried out with or without solvent. For uniformly mixing components, the reaction is preferably carried out with an organic solvent. Preferable examples of the solvent include organic solvents such as alcohols, aromatic hydrocarbons, ethers, ketones, or esters. The solvent is preferably capable of dissolving the silane compound and catalyst. It is also preferable to use a solvent as a coating liquid or a part of a coating liquid from the viewpoint of the process.

Among them, examples of alcohols include monovalent or divalent alcohols. Among monovalent alcohols, saturated aliphatic alcohols having 1 to 8 carbon atoms are preferable. Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, and ethylene glycol acetate monoethyl ether.

Specific examples of aromatic hydrocarbons include benzene, toluene, and xylene. Specific examples of ethers include tetrahydrofuran and dioxane. Specific examples of ketones include acetone, methyl ethyl ketone, methyl isobutyl ketone, and diisobutyl ketone. Specific examples of esters include ethyl acetate, propyl acetate, butyl acetate, and propylene carbonate.

These organic solvents may be used alone or in combination of two or more of them. The concentration of the solid content in the reaction is not particularly limited, but usually in the range of 1% to 90%, and preferably in the range of 20% to 70%.

The hydrolysis and condensation reactions of the silane compound are preferably carried out in the presence of a catalyst. Examples of the catalyst include organic acids such as oxalic acid, acetic acid, formic acid, methanesulfonic acid, or toluenesulfonic acid; inorganic salt groups such as ammonia; organic bases such as triethylamine or pyridine; and metal alkoxides such as triisopropoxy aluminum or tetrabutoxy zirconium. Among them, organic acids and metal alkoxides are preferable from the viewpoint of stability of preparation and storage stability of a sol solution.

Among organic acids, organic acids having an acid dissociation constant (pKa value (25° C.)) of 4.5 or lower in water are preferable, organic acids having an acid dissociation constant of 3.0 or lower in water are more preferable, organic acids having an acid dissociation constant of 2.5 or lower in water are further preferable, methanesulfonic acid, oxalic acid, phthalic acid, and malonic acid are further preferable, and oxalic acid is particularly preferable.

The hydrolysis or condensation reaction is usually carried out by adding 0.3 to 2 mol, and preferably 0.5 to 1 mol, of water relative to 1 mol of a hydrolysable group of the silane compound, and carrying out stirring at 25 to 100° C. in the presence or absence of the above-mentioned solvent, preferably in the presence of the catalyst.

When the hydrolysable group is an alkoxide and the catalyst is an organic acid, the addition amount of the water may be reduced so that the carboxyl group or sulfo group of the organic acid supplies protons. The addition amount of the water relative to 1 mol of the alkoxide group of the silane compound is 0 to 2 mol, preferably 0 to 1.5 mol, more preferably 0 to 1 mol, and particularly preferably 0 to 0.5 mol. When an alcohol is used as the solvent, the addition of substantially no water is also preferable.

When the catalyst is an organic acid, the optimal usage of the catalyst varies with the addition amount of water, and when water is added, 0.01 to 10 mol %, preferably 0.1 to 5 mol % relative to the total hydrolysable groups, and when substantially no water is added, 1 to 500 mol %, preferably 10 to 200 mol %, more preferably 20 to 200 mol %, further preferably 50 to 150 mol %, and most preferably 50 to 120 mol % relative to the hydrolysable groups. The reactions are carried out by stirring at 25 to 100° C., and preferably adjusted as appropriate according to the reactivity of the silane compound.

As described above, hydrolysates of the silane compound or partial condensates thereof (hereinafter they may be referred to as “sol composition”) are obtained. The sol composition is applied onto a support, or a support and a magnetic layer, and gelated to form a gelatinous composition. Thus, a non-magnetic layer containing the gelatinous composition is formed. The non-magnetic layer may contain, in addition to the gelatinous composition, various additives.

As the above-mentioned coating method, various methods can be used, such as air doctor coating, blade coating, rod coating, extrusion coating, air knife coating, squeeze coating, impregnation coating, reverse roll coating, transfer roll coating, gravure coating, kiss-roll coating, cast coating, spray coating, or spin coating.

For gelation of the sol composition, various methods can be used. Preferable example is heat treatment in which heating is carried out at 100 to 250° C., preferably 120 to 200° C. Furthermore, the thus formed non-magnetic layer is preferably cured by ultraviolet irradiation. The ultraviolet irradiation further enhances the strength of the film. The ultraviolet irradiation can be carried out using a commercially available black light.

The film thickness of the non-magnetic layer containing a gelatinous composition prepared by gelating a sol composition is preferably 1 to 2000 nm, and more preferably 3 to 500 nm under the magnetic layer, more specifically between the support and magnetic layer. Furthermore, on the magnetic layer, the thickness is preferably 1 to 20 nm, and more preferably 3 to 10 nm.

With regard to cases where a sol having a polymerizable group and a polymerizable monomer is used in combination, the monomer which can be used in combination and the method for polymerization curing are further described below.

Examples of monomers having two or more ethylene-based unsaturated groups include esters of a polyhydric alcohol and (meth)acrylic acid (e.g., ethyleneglycol di(meth)acrylate, 1,4-cyclohexane diacrylate, pentaerythritol tetra (meth)acrylate), pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, or polyester polyacrylate), vinyl benzenes and derivatives thereof (e.g, 1,4-divinylbenzene, 4-vinylbenzoic acid-2-acryloyl ethyl ester, or 1,4-divinyl cyclohexanone), vinyl sulfone (e.g., divinyl sulfone), acrylamide (e.g., methylene bisacrylamide) and methacryl amide. The above-mentioned monomers may be used in combination of two or more of them.

Furthermore, the above-mentioned multifunctional monomers may be used in combination with a monomer having one ethylene-based unsaturated group. The monomer unit which may be used in combination is not particularly limited, and examples thereof include olefins (e.g., 1-nonene or 1-dodecene), acrylic esters (e.g., butyl acrylate, hexyl acrylate, dodecyl acrylate, or 2-ethylhexyl acrylate), methacrylic esters (e.g., butyl methacrylate, decyl methacrylate, or hexadecyl methacrylate), styrene derivatives (e.g., styrene, vinyl toluene, or α-methyl styrene), vinyl ethers (e.g., ethyl vinyl ether, or cyclohexyl vinyl ether), vinyl esters (e.g., vinyl acetate, vinyl propionate, or vinyl cinnamate), acrylamides (N-tertbutyl acrylamide or N-cyclohexyl acrylamide), methacryl amides, and acrylonitrile derivatives.

Polymerization of the above monomers having ethylene-based unsaturated groups can be carried out by ionizing radiation or heating in the presence of a photoradical initiator or thermal radical initiator. Accordingly, the polymerization can be achieved by applying a monomer having ethylene-based unsaturated groups and a photoradical initiator or thermal radical initiator onto a transparent support, followed by ionizing radiation or heating.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums. Examples of acetophenones include 2,2-diethoxy acetophenone, p-dimethyl acetophenone, 1-hydroxydimethylphenyl ketone, 1-hydroxycyclohexylphenyl ketone, 2-methyl-4-methylthio-2-morpholino propiophenone, and 2-benzyl-2-dimethylamino-1-(4-morpholinophenyl)-butanone. Examples of benzoins include benzoin benzene sulfonate, benzoin toluene sulfonate, benzoin methyl ether, benzoin ethyl ether, and benzoin isopropyl ether. Examples of benzophenones include benzophenone, 2,4-dichlorobenzophenone, 4,4-dichlorobenzophenone, and p-chlorobenzophenone. Examples of phosphine oxides include 2,4,6-trimethylbenzoyldiphenylphosphine oxide.

Various examples described in “Saishin UV Koka Gijutsu (Latest UV Curing Technique)” (pp. 159, published by Kazuhiro Takausu, Technical Information Institute Co., Ltd., 1991) are also useful for the invention. Preferable examples of commercially available photoradical polymerization initiators of photocleavage type include Irgacure (651, 184, and 907) manufactured by Ciba-Geigy Japan Ltd.

The photopolymerization initiator is preferably added in the range of 0.1 to 15 parts by mass, more preferably in the range of 1 to 10 parts by mass relative to 100 parts by mass of a multifunctional monomer. In addition to the photopolymerization initiator, a light sensitizer may be used. Specific examples of the lightesensitizer include n-butylamine, triethylamine, tri-n-butylphosphine, Michler's ketone, and thioxanthone.

As the thermal radical initiator, organic or inorganic peroxides, organic azo and diazo compounds can be used. Specific examples of organic peroxides include benzoyl peroxide, halogen benzoyl peroxide, lauroyl peroxide, acetyl peroxide, dibutyl peroxide, cumene hydroperoxide, and butyl hydroperoxide; specific examples of inorganic peroxides include hydrogen peroxide, perammonium sulfate, and potassium persulfate; specific examples of azo compounds include 2-azo-bis-isobutyronitrile, 2-azo-bis-propionitrile, and 2-azo-bis-cyclohexanedinitrile; specific examples of diazo compounds include diazoaminobenzene, and p-nitrobenzene diazonium.

Polymer having polyether as a main chain thereof is preferably a ring-opened polymer of a multifunctional epoxy compound. Ring opening polymerization of a multifunctional epoxy compound can be carried out by ionizing radiation or heating in the presence of a photoacid generator or thermal acid generator.

Accordingly, a coating liquid containing a multifunctional epoxy compound, a photoacid generator or heat acid generator, mat particles, and an inorganic filler is prepared, the coating liquid is applied onto a transparent support, and cured by polymerization reaction through ionizing radiation or heating.

A crosslinking structure may be introduced to a binder polymer through the reaction of a crosslinking functional group which has been introduced to the polymer by a monomer having a crosslinking functional group used instead of or in addition to a monomer having two or more ethylene-based unsaturated groups.

Examples of the crosslinking functional group include an isocyanato group, epoxy group, aziridine group, oxazoline group, aldehyde group, carbonyl group, hydrazine group, carboxyl group, methylol group, and active methylene group.

Vinylsulfonic acids, acid anhydrides, cyanoacrylate derivatives, melamine, etherified methylol compounds, esters, urethanes, and metal alkoxides such as tetramethoxysilane are also useful as a monomer for introducing a crosslinked structure. A functional group which develops crosslinkability as a result of decomposition reaction, such as a blocked isocyanate group, may be also used. That is, in the invention, the crosslinking functional group may be either a ready-to-react one or one which shows reactivity as a result of decomposition. The binder polymers having the above-mentioned crosslinking functional group are applied and heated to form a crosslinked structure.

As described previously, a previously-mentioned non-magnetic layer may be formed as an ground layer between the support and magnetic layer. Formation of the ground layer enhances the adhesiveness to the support. The detail of the ground layer is same as that of the non-magnetic layer.

(Magnetic Layer)

The magnetic layer formed on the support of the magnetic recording medium of the invention contains magnetic nanoparticles having a number average particle diameter of 20 nm or less. A magnetic nanoparticle dispersion liquid in which the magnetic nanoparticles are dispersed is applied and dried, subsequently a non-magnetic layer is applied onto the magnetic layer, the magnetic nanoparticles are fixed, and annealing is carried out to ferromagnetize the magnetic layer. As a result, the magnetic nanoparticles are held without fusing with each other, which allows the production of a magnetic recording medium with less noise and high density. Furthermore, the magnetic recording medium is smooth and has high film strength.

The magnetic nanoparticles preferably comprise an alloy containing at least one of metals selected from Group 6 and Groups 8 through 15 in the periodic table. Particularly, from the viewpoint of obtaining ferromagnetism, either CuAu type ferromagnetic ordered alloys or Cu₃Au type ferromagnetic ordered alloys (hereinafter may be referred to as “ferromagnetic ordered alloy”) are preferable.

Examples of binary CuAu type ferromagnetic ordered alloys include FeNi, FePd, FePt, CoPt, and CoAu selected from Group 6 and Groups 8 through 10. Among them, FePd, FePt, and CoPt are preferable. Examples of Cu₃Au type ferromagnetic ordered alloys include Ni₃Fe, FePd₃, Fe₃Pt, FePt₃, CoPt₃, Ni₃Pt, CrPt₃, and Ni₃Mn. Among them, FePd₃, FePt₃, CoPt₃, Fe₃Pd, Fe₃Pt, and Co₃Pt are preferable.

The magnetic nanoparticles comprising the above-mentioned ferromagnetic ordered alloys are obtained by subjecting alloy particles comprising a ferromagnetic ordered alloy to annealing treatment and the like to cause phase transformation or the like for ferromagnetization. For decreasing the transformation temperature, it is preferable to add a metal selected from Groups 11 through 15, such as Sb, Pb, Bi, Cu, Ag, Zn, or In as a ferromagnetic ordered alloy. The addition amount is preferably 5 to 35 at %, and more preferably 10 to 30 at % relative to the ferromagnetic ordered alloy.

The method for producing the alloy particles used in the invention may be any one of the previously-mentioned methods (1) to (9), and preferably a reverse micelle method.

The reverse micelle method comprises: (1) a reduction process in which at least two of reverse micelle solutions are mixed and subjected to reduction reaction; and (2) an aging process in which aging is carried out after the reduction reaction at a predetermined temperature. These processes are further described below.

(1) Reduction Process:

In the first place, a reverse micelle solution (I) is prepared by mixing a water-insoluble organic solvent containing a surfactant with a reducing agent aqueous solution.

As the above-mentioned surfactant, an oil-soluble surfactant is used. Specific examples thereof include surfactants of sulfonate type (e.g., aerosol OT manufactured by Wako Pure Chemical Industries, Ltd.), quaternary ammonium salt type (e.g., cetyl trimethyl ammonium bromide), and ether type (e.g., pentaethyleneglycol dodecyl ether). The amount of the surfactant in a water-insoluble organic solvent is preferably 20 to 200 g/L.

Preferable examples of the water-insoluble organic solvent for dissolving the above-mentioned surfactant include alkane, ether, and alcohol. The alkane is preferably an alkane having 7 to 12 carbon atoms. Specifically, heptane, octane, isooctane, nonane, decane, undecane, dodecane, or the like are preferable. As the ether, diethyl ether, dipropyl ether, dibutyl ether, or the like are preferable. As the alcohol, ethoxy ethanol, ethoxy propanol, or the like are preferable.

As the reducing agent in the reducing agent aqueous solution, alcohols; polyalcohols; H₂; compounds containing HCHO, S₂O₆²⁻, H₂PO₂⁻, BH₄⁻, N₂H₅⁺, H₂PO₃⁻ or the like; are preferably used alone or in combination of two or more of them. The amount of the reducing agent in the aqueous solution is preferably 3 to 50 mol relative to 1 mol of a metal salt.

The mass ratio between the water and surfactant (water/surfactant) in the reverse micelle solution (I) is preferably 20 or less. When the mass ratio exceeds 20, precipitation tends to occur, and problems such as uneven particle diameter may occur. The mass ratio is preferably 15 or less, and more preferably 0.5 to 10.

In addition to the above-mentioned one, a reverse micelle solution (II) is prepared by mixing a water-insoluble organic solvent containing a surfactant with a metal salt aqueous solution. The conditions for the surfactant and water-insoluble organic solvent (e.g., substances to be used, and concentration) are the same for the reverse micelle solution (I). The compounds may be the same as or different from those used for the reverse micelle solution (I). The mass ratio between water and the surfactant in the reverse micelle solution (II) is same as that for the reverse micelle solution (I), and may be the same as or different from the mass ratio for the reverse micelle solution (I).

The metal salt contained in the metal salt aqueous solution is preferably selected as appropriate so that the magnetic particles to be prepared can form a CuAu type or Cu₃Au type ferromagnetic ordered alloy.

Examples of the CuAu type ferromagnetic ordered alloy and Cu₃Au type ferromagnetic ordered alloy include previously-mentioned examples.

Specific examples of the metal salt include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, Co(OCOCH₃)₂, and (NH₄)₂CuCl₄.

The concentration of the metal salt aqueous solution (as metal salt concentration) is preferably 0.1 to 1000 μmol/ml, and more preferably 1 to 100 μmol/ml.

Appropriate selection of the above-mentioned metal salt allows to prepare alloy particles which is capable of forming a CuAu type or Cu₃Au type ferromagnetic ordered alloy in which a base metal and a precious metal forms an alloy.

The alloy particles must be subjected to the annealing treatment mentioned below for transforming the alloy phase from an disordered phase to an ordered phase. For decreasing the transformation temperature, it is preferable to add a previously described third element to the above-mentioned binary alloy.

The reverse micelle solutions (I) and (II) prepared as described above are mixed. The method for mixing is not particularly limited, but in the light of the reduction evenness, the mixing is preferably performed by adding the reverse micelle solution (II) to the reverse micelle solution (I) while stirred. After the completion of the mixing, the reduction reaction is carried out, when the temperature is preferably constant in the range of −5 to 30° C.

When the reduction temperature is below −5° C., the aqueous phase coagulates and the reduction reaction tends to proceeds no uniformly, and when the temperature exceeds 30° C., aggregation or sedimentation tends to occur and the system may become unstable. The reduction temperature is preferably 0 to 25° C., and more preferably 5 to 25° C. The above-mentioned “constant temperature” means that when a predetermined temperature is T(° C.), T is within the range of T±3° C. In such cases, the upper limit and lower limit of T is within the range of the above-mentioned reduction temperature (−5 to 30° C.).

The time of the reduction reaction must be defined as appropriate on the basis of the amount of the reverse micelle solutions or the like, and preferably 1 to 30 minutes, and more preferably 5 to 20 minutes.

The reduction reaction is preferably carried out while stirred at a speed as fast as possible for giving a strong impact on the monodispersibility of the particle diameter distribution. The stirring apparatus is preferably a stirring apparatus having a high shearing force, and specifically a stirring apparatus in which stirring blades basically have a turbine type or paddle type structure, and a sharp blade is attached to the edge of the stirring blades or a position in contact with the stirring blades, and the stirring blades are rotated with a motor. Specifically, DISSOLVER (manufactured by Tokusyu Kika Kogyo Co, Ltd), OMNI mixer (manufactured by Yamato Scientific Co., Ltd.), and homogenizer (manufactured by SMT Co., Ltd.) are effective. By using the above apparatuses, monodispersed alloy particles can be synthesized as a stable dispersion liquid.

At least one of dispersant having one to three amino group(s) or carboxy group(s) is added to the above-mentioned reverse micelle solution (I) and/or (II), or in the aging process mentioned below. This allows obtaining monodispersed alloy particles with no aggregation.

The dispersant is preferably added in an amount of 0.001 to 10 mol relative to 1 mol of the alloy particles to be prepared. When the addition amount is less than 0.001 mol, the monodispersity of the alloy particles may not be further improved, and when the addition amount exceeds 10 mol, aggregation may occur.

As the above-mentioned dispersant, organic compounds having a group adsorbable to the surface of alloy particles are preferable. Specific examples are compounds having one to three amino group(s), carboxy group(s), sulfonic acid group(s) or sulfinic acid group(s), which may be used alone or in combination thereof.

With regard to the structural formula, the compound is represented by R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂, H—R—SO₂H, or SO₂H—R(SO₂H)—SO₂H, wherein R represents a straight, branched, or cyclic saturated or unsaturated hydrocarbon. Furthermore, it is preferable to use a dispersant having an alkylamine or carboxy group for preventing the aggregation of particles.

The alkylamine is not particularly limited, and may be primary to tertiary amine, monoamine, diamine, or triamine. Among them, alkylamines having a main skeleton having 4 to 20 carbon atoms are preferable, and alkylamines having a main skeleton having 8 to 18 carbon atoms are more preferable from the viewpoint of stability and handling property. Furthermore, all alkylamines effectively work as a dispersant, but primary alkylamines are preferably used from the viewpoint of stability and handling property. When the carbon atoms in the main chain of alkylamine is less than 4, the alkylamine has so strong basicity as an amine that it tends to corrode metal ultrafine particles and finally dissolve the ultrafine particules. Furthermore, when the carbon atoms in the main chain is more than 20, the viscosity of the alloy particle dispersion liquid increases as the concentration of the dispersion liquid is increased, which results in rather poor handling property.

Specific examples of alkylamine include primary amines such as butyl amine, octyl amine, dodecyl amine, hexadodecyl amine, octadecyl amine, cocoamine, talloamine, hydrogenated talloamine, oleyl amine, lauryl amine, or stearyl amine; secondary amines such as dicocoamine, dehydrogenated talloamine, or distearyl amine; and tertiary amines such as dodecyldimethyl amine, didodecylmonomethyl amine, tetradecyldimethyl amine, octadecyldimethyl amine, cocodimethyl amine, dodecyltetradecyldimethyl amine, or trioctyl amine. Other examples include diamines such as naphthalene diamine, stearylpropylene diamine, octamethylene diamine, or nonane diamine.

The dispersant having carboxy group(s) include compounds represented by the structural formula R—COOH, COOH—R—COOH, or COOH—R(COOH)COOH. In the formula, R represents a straight, branched or cyclic saturated or unsaturated hydrocarbon.

The dispersant having carboxy group(s) is particularly preferably oleic acid. Oleic acid is a well known surfactant for stabilization of colloids, and has been used for the protection of metal particles such as iron. Oleic acid has a relatively long chain which gives an important steric hindrance for countering the strong magnetic interaction between particles. For example, oleic acid has a 18-carbon chain, and the length is 20 angstrom or less (2 nm or less). Oleic acid is not aliphatic and has a double bond.

Similar long-chain carboxylic acids such as erucic acid or linolic acid may be used in the same manner as oleic acid. For example, long-chain organic acids having 8 to 22 carbon atoms may be used alone or in combination. Oleic acid (e.g., olive oil) is preferable because it is a low-cost natural resource easily available. Furthermore, oleic acid derived from oleyl amine is also as useful a dispersant as oleic acid.

In the above-mentioned reduction process, it is considered that base metals having an oxidation reduction potential of about −0.2 V (vs. N. H. E) or lower, such as Co, Fe, Ni, or Cr, in the CuAu type or Cu₃Au type ferromagnetic ordered alloy phase are reduced, and deposited in a minimal size and in a monodispersed state. Subsequently, in the temperature rising process and the aging process mentioned below, on the surface of the deposited base metals as a core, precious metals having an oxidation reduction potential of about −0.2 V (vs. N. H. E) or higher, such as Pt, Pd, or Rh, are reduced by base metals, substituted, and deposited. Ionized base metals are considered to be reduced again by a reducing agent, and deposited. Through the repetition of the above processes, alloy particles which are capable of forming the CuAu type or Cu₃Au type ferromagnetic ordered alloy can be obtained.

(2) Aging Process:

After the completion of the reduction reaction, the reacted solution is heated to the aging temperature.

The above-mentioned aging temperature is preferably a constant temperature between 30 and 90° C., and the temperature must be higher than the temperature of the above-mentioned reduction reaction. Furthermore, the aging time is preferably 5 to 180 minute. When the aging temperature and time are higher than the above-mentioned range, aggregation or sedimentation tends to occur, and when lower than the range, the reaction may fail to complete and the composition may be varied. Preferable aging temperature and time are 40 to 80° C. and 10 to 150 minutes, respectively, and more preferable aging temperature and time are 40 to 70° C. and 20 to 120 minutes, respectively.

The above-mentioned “constant temperature” is equivalent to that for the temperature of the reduction reaction (in this case, “reduction temperature” is replaced with “aging temperature”). Particularly, within the range of the above-mentioned aging temperature (30 to 90° C.), the aging temperature is preferably higher than the temperature of the reduction reaction by 5° C. or more, and more preferably 10° C. or more. When the temperature difference is less than 5° C., a composition according to the formula may fail to be obtained.

In the above aging process, precious metals are deposited on base metals which have been reduced and deposited in the reduction process. More specifically, the reductions of precious metals occur only on base metals, and base metals and precious metals will not separately deposited. This allows preparing the alloy particles, which are capable of effectively forming the CuAu type or Cu₃Au type ferromagnetic ordered alloy, at a high yield according to the formulated composition proportions, and the particles can be adjusted to a desired composition. Furthermore, by appropriately adjusting the stirring rate of the temperature during aging, the alloy particles to be obtained can be made into a desired particle diameter.

After carrying out the aging, the aged solution is washed with a mixed solution of water and a primary alcohol, subsequently precipitating treatment is carried out with the primary alcohol to produce precipitate, and preferably the precipitate is subjected to a washing/dispersing process in which the precipitate is dispersed in an organic solvent. The washing/dispersing process removes impurities, which allows furthering improving the application property of the magnetic layer of the magnetic recording medium when the layer is formed by application. The above-mentioned washing and dispersion are carried out at least once each, preferably twice or more each.

The above-mentioned primary alcohol used for washing is not particularly limited, but preferably methanol, ethanol, or the like. The volume mixing ratio (water/primary alcohol) is preferably in the range of 10/1 to 2/1, and more preferably in the range of 5/1 to 3/1.

When the ratio of water is higher, surfactants may be hard to remove, and when the ratio of the primary alcohol is higher, aggregation may occur.

As described above, alloy particles dispersed in a solution (referred to as an alloy particle-containing liquid or magnetic nanoparticle dispersion liquid). Since the alloy particles are monodispersed, when they are applied onto a support, they remain in a uniformly dispersed state without causing aggregation. The alloy particles does not cause aggregation each other even by annealing treatment, therefore they can be effectively ferromagnetized and offers excellent application property.

The alloy particle-containing liquid as the coating liquid is applied onto a support or non-magnetic layer to form a magnetic layer. The application is carried out in such a manner that the film thickness of the dried magnetic layer is preferably within the range of 5 nm to 200 nm, more preferably within the range of 5 nm to 100 nm, and further preferably within the range of 5 nm to 50 nm. The drying temperature is preferably 100 to 300° C.

As the coating liquid, the previously-mentioned alloy particle coating liquid can be used. In actuality, it is preferable to appropriately add known additives, various solvents, or the like to the alloy particle coating liquid to adjust the content of the alloy particles to a desired level (0.01 to 0.1 mg/ml).

Furthermore, plural coating liquids may be applied sequentially or simultaneously to form multiple layers. The magnetic layer may be made into a multiple layer structure for improving the electromagnetic conversion property.

As the method for applying the coating liquid, air doctor coating, blade coating, rod coating, extrusion coating, air knife coating, squeeze coating, impregnation coating, reverse roll coating, transfer roll coating, gravure coating, kiss-roll coating, cast coating, spray coating, spin coating, or the like can be used.

As the support, either inorganic or organic supports may be used. As the inorganic support, Al, Mg alloy such as Al—Mg alloy, or Mg—Al—Zn, glass, quartz, carbon, silicon, ceramic and the like are used. These supports have excellent impact resistance, and have stiffness suitable to thinning and high-speed rotation. Furthermore, they have higher heat resistance than organic supports.

As the organic support, polyesters such as polyethylene terephthalate, or polyethylene naphthalate, polyolefins, cellulosetriacetate, polycarbonate, polyamide (including aromatic polyamides such as aliphatic polyamide or aramid), polyimide, polyamide imide, polysulfone, polybenzoxazole, or the like can be used.

Since the alloy particles before annealing is usually disordered, they must be annealed to be ordered for developing ferromagnetism. The annealing treatment is preferably carried out by heating on the support after application for preventing the fusion between the particles. Heating must be carried out at a temperature higher than the order-disorder transformation temperature of the alloy constituting the alloy particles determined by difference heat analysis (DTA).

When an organic support is used, it is effective to heat the magnetic layer alone using laser. When laser is used, laser wavelengths from ultraviolet to infrared can be used, but a laser beam with visible to infrared wavelengths is preferably used because an organic support has an absorption in the ultraviolet region.

From the viewpoint of the wavelength and output of laser, examples of preferable laser include Ar ion laser, Cu steam laser, HF chemical laser, dye laser, ruby laser, YAG laser, glass laser, titanium sapphire laser, alexandrite laser, and GaAlAs array semiconductor laser.

The conditions for laser output and linear velocity must be defined so that the magnetic nanoparticles sufficiently cause ordered crystallization, and do not cause ablation. The output and linear velocity must be adequately defined by the laser beam source. Higher output and higher linear velocity are preferable for improving the productivity.

As described in JP-A No. 2004-5937, the magnetic layer of the magnetic recording medium of the invention preferably contains a non-magnetic metal oxide matrix.

As the nonmetal oxide matrix agent used in the invention, silica, titania and polysiloxane are preferable, specifically, organosilica sols (e.g., silica sol manufactured by Nissan Chemical Industries, Ltd., NANOTECH SiO₂, manufactured by C.I. Kasei Co., Ltd.), organotitania sols (e.g., NANOTECH TiO₂, manufactured by C.I. Kasei Co., Ltd.) and silicone resins (e.g., TORAYFIL R910, manufactured by Toray Silicon Company Ltd.) are preferable.

The addition amount of the non-magnetic metal oxide matrix agent is 1 to 200 volume %, preferably 5 to 100 volume %, and more preferably 10 to 50 volume % relative to the magnetic particles.

The coercive force of the magnetic particles obtained by annealing the magnetic nanoparticles is preferably 95.5 to 636.8 kA/m (1200 to 80000 Oe).

The method for annealing the magnetic nanoparticles at a temperature higher than the transformation temperature may be selected arbitrarily, but preferably a method using an infrared lamp or laser beam.

The magnetic nanoparticles according to the invention have a number average particle diameter of 20 nm or less, preferably 1 to 20 nm, and more preferably 3 to 10 nm. When the diameter exceeds 20 nm, noise increases, and recording density decreases.

As a magnetic recording medium, the magnetic particles are preferably closely packed for increasing the recording capacity. For the purpose, the coefficient of variation of the magnetic nanoparticles is preferably less than 15%, and more preferably 10% or less. Too small particle diameter is not preferable because particles become super paramagnetic due to thermal fluctuation. The minimum stable particle diameter varies with the constituent elements. For obtaining a necessary particle diameter, it is effective to prepare the particles with varying the mass ratio between H₂O and a surfactant in the reverse micelle method.

For the evaluation of the particle diameter of the magnetic nanoparticles, a transmission electron microscope (TEM) can be used. Crystal system of the magnetic particles ferromagnetized by annealing may be determined by electron beam diffraction with a TEM. However, X ray diffraction is better for achieving higher precision. The composition analysis of the inside of the ferromagnetized magnetic particles is preferably evaluated by FE-TEM/EDS which is capable of thinning down electron beam. The magnetic properties of the ferromagnetized magnetic particles can be evaluated using VSM.

(Protective Layer)

In the magnetic recording medium of the invention, a protective layer may be formed on the above-mentioned non-magnetic layer. The protective layer can improve abrasion resistance. Furthermore, it is also effective to apply a lubricant on the protective surface to form a lubricant layer for securing adequate reliability with enhanced lubricity.

Examples of the protective layer include protective layers comprising oxides such as silica, alumina, titania, zirconia, cobalt oxides, or nickel oxides; nitrides such as titanium nitride, silicon nitride, or boron nitride; carbides such as silicon carbide, chromium carbide, or boron carbide; or carbon such as graphite or amorphous carbon. Among them, carbon protective layers comprising carbon are preferable. Furthermore, among carbon protective layers, hard amorphous carbon usually referred to as diamond-like carbon is particularly preferable.

As the method for forming a carbon protective layer, a sputtering method is commonly used for hard disks. For products which require continuous film formation, such as video tapes, many methods using plasma CVD, which offers higher film formation rates, are supposed. Among them, plasma injection CVD (PI-CVD) method is reported to offer very high film formation speed, and produce good-quality hard carbon protective layers with less pinholes (for example, see JP-A Nos. 61-130487, 63-279426, and 3-113824).

The carbon protective layer is a hard carbon film having a Vickers hardness of 1000 kg/mm² or more, and preferably 2000kg/mm² or more. Furthermore, the crystal structure is an amorphous structure, and nonconducting. When a diamond-like carbon film is used as the carbon protective layer, the structure is confirmed by the detection of a peak at 1520 to 1560 cm⁻¹ by Raman spectroscopy. When the film structure deviates from the diamond-like structure, the peak detected by Raman spectroscopy deviates from the above-mentioned range, and the film hardness decreases.

As the materials for preparing the carbon protective layer, carbon-containing compounds can be used, for example, alkanes such as methane, ethane, propane, or butane; alkene such as ethylene or propylene; alkines such as acetylene. Furthermore, if necessary, carrier gases such as argon or additive gases such as hydrogen or nitrogen may be added.

When the film thickness of the carbon protective layer is high, electromagnetic conversion properties and adhesiveness to the magnetic layer may deteriorate, and when the film thickness is small, abrasion resistance may be insufficient. Therefore, the film thickness is preferably 1 to 20 nm, and more preferably 2 to 10 nm. Furthermore, for improving the adhesiveness between the hard carbon protective layer and the ferromagnetic metal thin film as support, the surface of the ferromagnetic metal thin film may be modified in advance by etching with an inert gas or exposure to reactive gas plasma such as oxygen.

As the lubricant for forming the lubricant layer, known hydrocarbon-based lubricants, fluorine-based lubricants, extreme pressure additives, or the like can be used.

Examples of hydrocarbon-based lubricants include carboxylic acids such as stearic acid or oleic acid; esters such as butyl stearate; sulfonic acids such as octadecylsulfonic acid; phosphoric acid esters such as monooctadecyl phosphate; alcohols such as stearyl alcohol, or oleyl alcohol; carboxylic acid amides such as stearic acid amide; and amines such as stearylamine.

Examples of fluorine-based lubricants include lubricants in which alkyl groups of the above-mentioned hydrocarbon-based lubricant are partially or completely substituted with fluoroalkyl groups or perfluoropolyether groups.

Examples of perfluoropolyether groups include perfluoromethylene oxide polymer, perfluoroethylene oxide polymer, perfluoro-n-propylene oxide polymer (CF₂CF₂CF₂O)ₙ, perfluoroisopropylene oxide polymer (CF(CF₃)CF₂O)ₙ or copolymers thereof. Furthermore, compounds having polar functional groups such as hydroxy group, ester group, or carboxyl group at the ends or within the molecule are preferable because they are highly effective for reducing friction force. These compounds preferably have a molecular weight of 500 to 5000, and more preferably 1000 to 3000. When the molecular weight is less than the above-mentioned range, volatility may increase, and lubricity may decrease. Furthermore, when the molecular weight exceeds the above-mentioned range, the viscosity becomes high so that the slider and the disk are likely to adhere to each other, thereby causing operation stop or head crush.

Specific examples of the lubricants substituted with perfluoropolyether include commercial products available in trade names of FOMBLFN manufactured by Ausimont, Inc. and KRYTOX manufactured by Du Pont K.K.

Examples of extreme pressure additives include phosphoric esters such as trilauryl phosphate, phosphorous esters such as trilauryl phosphate, thiophosphorous esters and thiophosphorous esters such as trilauryl trithiophosphite, and sulfur-based extreme pressure agents such as dibenzyl disulfide.

The above-mentioned lubricants are used alone or in combination of a plurality of them. As a method for applying these lubricants onto the magnetic layer or protective layer, a lubricant is dissolved in an organic solvent, and applied by a wire bar method, gravure method, spin coat method, dip-coat method, or the like, or deposited by a vacuum deposition method.

A rust-preventive agent may be applied onto the magnetic recording medium of the invention.

Examples of rust-preventive agents include nitrogen-containing heterocycles such as benzotriazole, benzimidazole, purine and pyrimidine, and derivatives thereof that are obtained by introducing an alkyl side chain or the like to their mother nucleus; nitrogen- and sulfur-containing heterocycles such as benzothiazole, 2-mercaptobenzothiazole, tetrazaindene cyclic compounds, and thiouracil compounds, and derivatives thereof.

When the support used in the invention is provided with a back coat layer (baking layer) on the side thereof having no magnetic layer, the back coat layer can be provided on the side of the support having no magnetic layer by applying a back coat layer forming paint in which granular components such as an abrasive and anti-static agent, and a binding agent have been dispersed in an organic solvent.

As the granular components, various inorganic pigments or carbon black can be used. As the binding agent, nitro cellulose, phenoxy resins, vinyl chloride-based resins, polyurethane, and other resins can be used alone or in combination thereof. Furthermore, an adhesive layer may be provided on the support on the side coated with the dispersion liquid of alloy particles and the back coat layer forming paint.

The above-mentioned magnetic recording medium may be subjected to calendaring or varnish treatment for producing a surface with highly excellent smoothness. Furthermore, the obtained magnetic recording medium may be used after being punched with a punching apparatus or properly cut into a desired size by a cutting apparatus.

Examples of the magnetic recording medium of the invention include video tapes, computer tapes, floppy (registered trademark) disks, and hard disks. Application to MRAM is also preferable.

### EXAMPLES

The invention is further illustrated on the basis of following Examples, but the invention is not limited within the range.

<Synthesis of Organosilane Sol Composition>

(Preparation of Organosilane Sol Composition a-1)

48 g of acryloyloxypropyltrimethoxysilane (compound example (18)), 37 g of oxalic acid, and 124 g of ethanol were placed and mixed in a reaction vessel equipped with a stirrer and a reflux condenser, allowed to react at 70° C. for 5 hours, and then cooled to room temperature to obtain a sol composition a-1.

(Preparation of Organosilane Sol Composition a-2)

48 g of acryloyloxypropyltrimethoxysilane, 0.84 g of aluminum diisopropoxide ethyl acetoacetate, 60 g of methyl ethyl ketone, 0.06g of hydroquinone monomethyl ether, and 11.1 g of water were placed and mixed in a reaction vessel equipped with a stirrer and a reflux condenser, allowed to react at 60° C. for 4 hours, and then cooled to room temperature to obtain a sol composition a-2.

(Preparation of Organosilane Sol Composition a-3)

A transparent sol composition a-3 was obtained by the same procedure as the sol composition a-2 except that acryloyloxypropyltrimethoxysilane used in the preparation of the sol composition a-2 was replaced with methacryloyloxypropyltrimethoxysilane (compound example (19)).

(Preparation of Organosilane Sol Composition a-4)

A sol composition a-4 was obtained by the same procedure as the sol composition a-2 except that 48 g of acryloyloxypropyltrimethoxysilane used in the preparation of the sol composition a-2 was replaced with a mixture of 28 g of acryloyloxypropyltrimethoxysilane and 20 g of glycidoxypropyltrimethoxysilane (compound example (11)).

(Preparation of Organosilane Sol Composition a-5)

48 g of methacryloyloxypropyltrimethoxysilane, 24 g of oxalic acid, and 124 g of ethanol were placed and mixed in a reaction vessel equipped with a stirrer and a reflux condenser, allowed to react at 70° C. for 5 hours, and then cooled to room temperature, 13 g of ethanol was added to obtain a sol composition a-5.

(Preparation of Organosilane Sol Composition a-6)

A sol composition a-6 was obtained by the same procedure as the sol composition a-5 except that oxalic acid used in the preparation of the sol composition a-5 was replaced with malonic acid.

(Preparation of Organosilane Sol Composition a-7)

A sol composition a-7 was obtained by the same procedure as the sol composition a-3 except that the half quantity of methacryloyloxypropyltrimethoxysilane used in the preparation of the sol composition a-3 was replaced with tetraethoxysilane (compound example (1)).

All of the above-mentioned sol compositions a-1 through a-7 contained oligomer or polymer components (components having a weight average molecular weight of 1000 to 20000) in an amount of 100%.

<Synthesis of FePt Alloy Particles>

The following operation was carried out in an atmosphere of high purity N₂ gas.

To an aqueous solution containing 0.57 g of NaBH₄ (manufactured by Wako Pure Chemical Industries, Ltd.) and 24 ml of H₂O (deoxygenated), a solution containing 16 g of AEROSOL OT (manufactured by Wako Pure Chemical Industries, Ltd.) and 120 ml of decane (manufactured by Wako Pure Chemical Industries, Ltd.) was added, and mixed to prepare a reverse micelle solution (A). To an aqueous solution containing 0.46 g of iron triammonium trioxalate (Fe(NH₄)₃(C₂O₄)₃) (manufactured by Wako Pure Chemical Industries, Ltd.), 0.38 g of potassium chloroplatinate (K₂PtCl₄) (manufactured by Wako Pure Chemical Industries, Ltd.), and 24 ml of H₂O (deoxygenated), a solution containing 16 g of AEROSOL OT and 120 ml of decane was added, and mixed to prepare a reverse micelle solution (B). To an aqueous solution containing 0.44 g of L-ascorbic acid (manufactured by Wako Pure Chemical Industries, Ltd.) and 12 ml of H₂O (deoxygenated), a solution containing 8 g of AEROSOL OT, 60 ml of decane, and 3 ml of oleyl amine (manufactured by Tokyo Chemical Industry Co., Ltd.) was added, and mixed to prepare a reverse micelle solution (C). While the reverse micelle solution (A) was being stirred at high speed in an OMNIMIXER (manufactured by Yamato Scientific Co., Ltd.) at 22° C., the reverse micelle solution (B) was added instantaneously. Four minutes later, the reverse micelle solution (C) was added instantaneously. Further four minutes later, the mixture solution was heated to 40° C. while being stirred with a magnetic stirrer and aged for 120 minutes. 3 ml of oleic acid (manufactured by Wako Pure Chemical Industries, Ltd.) was added, and the solution was cooled to room temperature. The cooled solution was taken out in the air.

In order to break the reverse micelle, a mixture of 450 ml of H₂O and 450 ml of methanol was added to separate the water phase from the oil phase. The alloy particles were dispersed in the oil phase. The oil phase was washed once with a mixture of 900 ml of H₂O and 300 ml of methanol. Subsequently, 2200 ml of methanol was added to the oil phase to cause the alloy particles to flocculate and sediment. The supernatant was removed, 60 ml of heptane (manufactured by Wako Pure Chemical Industries, Ltd.) was added, and the alloy particles were dispersed again. The series of the sedimentation by addition of 300 ml of methanol and the dispersion by addition of 60 ml of heptane were repeated twice. Finally, 15 ml of heptane was added to prepare an alloy particle dispersion liquid containing dispersed alloy particles. The obtained alloy particles (FePt) were analyzed to obtain the results described below. The composition and yield were measured by ICP spectroscopy analysis (inductively coupled high frequency plasma spectroscopy analysis). The average particle diameter (number average particle diameter) and distribution were determined by measuring the particles photographed with a TEM and statistically processing the obtained data.

The coercive force was determined by measuring a sample of heated magnetic particles, which are described later, using a high-sensitivity magnetization vector measuring device and a DATA processor (both manufactured by Toei Industry Co., Ltd.) with an applied magnetic field of 20 kOe.

Composition: FePt alloy containing 45.2 at % of Pt; yield: 80%; average particle diameter: 4.8 nm; coefficient of variation: 5%, coercive force: 5150 Oe (infrared radiation heating furnace (manufactured by Ulvac-RiKo,Inc, in an atmosphere of mixed gas of Ar and H₂ (5%), 500° C., after heated for 30 minutes)

<Preparation of Magnetic Recording Medium>

### Example 1

(1) Formation of Non-Magnetic Ground Layer:

A sample prepared was formed by applying the organosilane sol composition a-2 onto a glass substrate (manufactured by Toyo Kohan Co., Ltd.) as support using a spin coater, and dried at 150° C. for about 25 minutes to form a non-magnetic layer having a thickness of about 30 nm.

(2) Formation of Magnetic Layer:

A coating liquid comprising the above-mentioned FePt alloy particles dispersion liquid and 30 vol % of a silicone resin (trade name: TORAYFIL, manufactured by Toray Silicon Company Ltd.) was applied onto the non-magnetic ground layer by a spin coater. The coating weight was 0.4 g/m². In order to volatilize the solvent, drying was carried out at 250° C. for 25 minutes. The thickness was about 30 nm.

(3) Formation of Non-Magnetic Protective Layer:

Samples were prepared by applying each of the above-mentioned organosilane sol compositions a-1 to a-7 onto the magnetic layer using a spin coater, and dried at 150° C. for about 25 minutes to form a non-magnetic layer having a thickness of about 5 nm. Furthermore, the layer was heated in an atmosphere of a mixed gas of Ar and H₂ (5%) at 500° C. for 30 minutes in an electric furnace to cause the phase transformation of the magnetic nanoparticles from disordered crystals to ordered crystals.

(4) Formation of Carbon Protective Layer:

The magnetic media coated with the above-mentioned (1) through (3) were mounted on a plasma injection CVD apparatus (manufactured by ASTeX Inc.) in such a manner that the distance between the tip of the reaction tube and the substrate was 22 mm.

Subsequently, a vacuum tank was evacuated to a pressure of 399×10⁻⁶ Pa, and 150 sccm of ethylene gas and 50 sccm of argon gas were introduced from a gas inlet tube to the reaction tube to achieve a pressure of 1.33 Pa. In that condition, a high frequency wave of 13.56 MHz was applied to the excitation coil of the reaction tube with electric power of 450 W to generate plasma of the feed gas (ethylene gas). A bias of −400V was applied to the support, and a bias +500V was applied to the anode electrode. A carbon protective layer was formed in such a manner that the film thickness at the center part was 2 nm.

(5) Formation of Lubricant Layer:

A mixture of phosphoric acid monolauryl ester and perfluorooctane acid stearyl ester was applied onto each of the carbon protective layers formed above by spin coating in a coating weight of 3 mg/m². Thus magnetic recording media A through G comprising a support having thereon a non-magnetic ground layer, a magnetic layer, a non-magnetic protective layer, a carbon protective layer, and a lubricant layer in this order were prepared. The total film thickness of the protective layer and the lubricant layer was about 3 nm.

### Example 2

In response to the magnetic recording media B and D prepared in Example 1 using sol compositions a-2 and a-4, magnetic recording media H and I were prepared without forming a carbon protective layer.

### Comparative Example 1

A magnetic recording medium J was prepared in the same manner as Example 1, except that no non-magnetic ground layer was applied, no silicone resin was contained in the magnetic layer, and the same heating treatment as Example 1 was carried out before the non-magnetic protective layer was applied.

### Comparative Example 2

A magnetic recording medium K was prepared in the same manner as Example 1, except that no non-magnetic ground layer was applied, and the same heating treatment as Example 1 was carried out before the non-magnetic protective layer was applied.

### Comparative Example 3

A magnetic recording medium L was prepared in the same manner as Example 1, except that the same heating treatment as Example 1 was carried out before the non-magnetic protective layer was applied.

<Evaluation of Degree of Fusion, Smoothness, and Film Strength>

For examining the degree of fusion of the magnetic recording media A through L prepared in Examples 1 and 2, and Comparative Examples 1, 2, and 3, about 600 particle images taken using a TEM (trade name: JEM-2000FX, manufactured by JEOL Ltd.) at a magnification of 100000 were observed, and the number of fused particles was expressed as %.

Furthermore, for examining the smoothness, the magnetic recording media were mounted on an AFM (trade name: NANOSCOPE III, manufactured by Digital Instruments Inc.), and the surface roughness (Ra) in an area of 10 μm×10 μm was evaluated.

Furthermore, the media were mounted on a spin stand for evaluating the electromagnetic conversion property of hard disks (trade name: SS-60, GUZIK RWA-1601, manufactured by Kyodo Electronics Inc.), and the film strength was evaluated by the susceptibility to scratches. The numbers of scratches were determined from the average of three points between radiuses of 40 to 60 mm from the center which were continuously observed with an optical microscope (magnification ×100). The results are shown in Table 1 below.

TABLE 1

| | | | Film strength |
|---|---|---|---|
| | | | (number of |
| Magnetic recording | Degree | Smoothness | scratches = count/ |
| medium | of fusion (%) | (Ra: nm) | mm²) |
| A (Example 1) | 1.3 | 1.4 | 2 |
| B (Example 1) | 0.9 | 1.2 | 2 |
| C (Example 1) | 1.0 | 1.0 | 1 |
| D (Example 1) | 1.2 | 0.9 | 0 |
| E (Example 1) | 0.8 | 1.3 | 2 |
| F (Example 1) | 1.2 | 1.4 | 1 |
| G (Example 1) | 1.1 | 0.9 | 0 |
| H (Example 2) | 0.9 | 1.1 | 1 |
| I (Example 2) | 1.1 | 0.7 | 0 |
| J (Comparative | 78.9 | 5.8 | 25 |
| Example 1) | | | |
| K (Comparative | 34.3 | 5.1 | 13 |
| Example 2) | | | |
| L (Comparative | 18.8 | 4.2 | 6 |
| Example 3) | | | |

As is evident from Table 1, it was shown that the magnetic recording media A through G of the Examples, in which a hydrolysate or partial condensate of the silane compound was used as the non-magnetic ground layer and the non-magnetic protective layer, hardly exhibited fusion between magnetic nanoparticles and offered excellent smoothness and film strength. It was also shown that the magnetic recording media H and I of the Examples maintained the performance thereof even without a carbon protective layer which is commonly used. Furthermore, it was shown that all of the magnetic recording media A through I of the Examples exhibited excellent adhesiveness to the glass substrate and caused no film peeling in a running durability test using the above-mentioned spin stand.

<Evaluation of Electromagnetic Conversion Property>

The magnetic recording media of Examples 1 and 2, and Comparative Examples 1, 2, and 3 were mounted on a spin stand for evaluating the electromagnetic conversion property of hard disks (trade name: SS-60, GUZIK RWA-1601, manufactured by Kyodo Electronics Inc.), and evaluated for record and reproduction.

The magnetic recording media of Comparative Example 1, Comparative Example 2, and Comparative Example 3 coated with the lubricant layer were scratched by the head and could not be evaluated for recording and reproduction. On the other hand, the magnetic recording media of Examples 1 and 2 coated with the lubricant layer were capable of recording and reproduction.

What is claimed is:

1. A magnetic recording medium comprising a support having thereon a magnetic layer and a non-magnetic layer in this order,
the magnetic layer being formed by applying and drying a magnetic nanoparticle dispersion liquid in which magnetic nanoparticles having a number average particle diameter of 20 nm or less are dispersed, applying the non-magnetic layer onto the magnetic layer, fixing the magnetic nanoparticles, and carrying out annealing for ferromagnetization, and
the non-magnetic layer comprising a gelatinous composition formed by gelating at least one selected from the group consisting of hydrolysates of the silane compound represented by the following formula (1) and partial condensates thereof,
(R¹⁰)ₘ—Si(X)₄₋ₘ Formula (1)
wherein, in the formula (1), R¹⁰ represents a substituted or unsubstituted alkyl group, or a substituted or unsubstituted aryl group, X represents a hydroxy group or hydrolyzable group, and m represents an integer from 1 to 3.

2. The magnetic recording medium of claim 1, wherein X in the formula (1) is an alkoxy group.

3. The magnetic recording medium of claim 1 wherein m in the formula (1) is 2 or 3, and at least one of the R¹⁰s is is a substituted alkyl group or substituted aryl group.

4. The magnetic recording medium of claim 1, wherein the silane compound is an organosilane compound represented by the following formula (2): 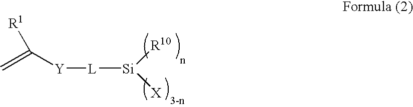
wherein, in the formula (2), R¹⁰ represents a substituted or unsubstituted alkyl group, or a substituted or unsubstituted aryl group; X represents a hydroxy group or hydrolyzable group; n represents 1 or 2; R¹ represents a hydrogen atom, methyl group, methoxy group, alkoxycarbonyl group, cyano group, fluorine atom, or chlorine atom; Y represents a single bond, ester group, amide group, ether group, or urea group; and L represents a divalent linking chain.

5. The magnetic recording medium of claim 1, wherein the non-magnetic layer is cured by heat or ultraviolet radiation.

6. The magnetic recording medium of claim 1, wherein the magnetic nanoparticles comprise an alloy containing at least two or more metals selected from Group 6 and Groups 8 through 15 in the periodic table.

7. The magnetic recording medium of claim 1, wherein another non-magnetic layer is provided between the support and the magnetic layer, the another non-magnetic layer containing a gelatinous composition formed by gelating at least one selected from the group consisting of hydrolysates of a silane compound represented by the following formula (1) and partial condensates thereof:
(R¹⁰)ₘ—Si(X)₄₋ₘ Formula (1)
wherein, in the formula (1), R¹⁰ represents a substituted or unsubstituted alkyl group, or a substituted or unsubstituted aryl group, X represents a hydroxy group or hydrolyzable group, and m represents an integer from 1 to 3.

8. The magnetic recording medium of claim 7, wherein X in the formula (1) is an alkoxy group.

9. The magnetic recording medium of claim 7 wherein m in the formula (1) is 2 or 3, and at least one of the R¹⁰s is a substituted alkyl group or substituted aryl group.

10. The magnetic recording medium of claim 7, wherein the silane compound is an organosilane compound represented by the following formula (2): 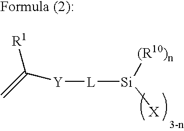
wherein, in the formula (2), R¹⁰ represents a substituted or unsubstituted alkyl group, or a substituted or unsubstituted aryl group; X represents a hydroxy group or hydrolyzable group; n represents 1 or 2; R¹ represents a hydrogen atom, methyl group, methoxy group; alkoxycarbonyl group, cyano group, fluorine atom, or chlorine atom; Y represents a single bond, ester group, amide group, ether group, or urea group; L represents a divalent linking chain.

11. The magnetic recording medium of claim 1, wherein a carbon protective layer is formed.

12. The magnetic recording medium of claim 11, wherein a lubricant layer is formed on the carbon protective layer.
